(19) United States
(12) Patent Application Publication
(10) Pub. No.: US 2026/0100521 A1
(43) Pub. Date: Apr. 9, 2026

(54) ELECTRICAL CONNECTION UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kenichi KITAOKA, Mie (JP); Akihiro HAYASHI, Mie (JP); Daisuke HASHIMOTO, Mie (JP); Kentaro TACHI, Mie (JP)

(21) Appl. No.: 19/109,569

(22) PCT Filed: Aug. 29, 2023
(86) PCT No.: PCT/JP2023/031183

§ 371 Date: Mar. 7, 2025

(30) Foreign Application Priority Data
Sep. 16, 2022 (JP) 2022-147552

(51) Int. Cl. H01R 4/01; H01R 4/48

(52) U.S. Cl. CPC H01R 4/01; H01R 4/4809

(57) ABSTRACT

It is aimed to enable a connecting operation to be easily performed while achieving high connection reliability between a connecting member and a mating connecting member. An electrical connection unit is to be connected to a mating connecting member and includes a connecting member capable of contacting the mating connecting member and a biasing member for applying a contact pressure between the mating connecting member and the connecting member. The biasing member is made of shape-memory alloy memorizing a shape to enhance the contact pressure by a temperature increase.

### TECHNICAL FIELD

The present disclosure relates to an electrical connection unit.

### BACKGROUND

Patent Document 1 discloses a zero insertion force connector provided with a shape-memory spring. In Patent Document 1, if the shape-memory spring is energized and heated, a female pin is opened by a shape recovery force of the shape-memory spring. In this way, an attachment force in inserting a male pin into the female pin can be zeroed.

### PRIOR ART DOCUMENT

### Patent Document

Patent Document 1: JP H08-167456 A

### SUMMARY OF THE INVENTION

### Problems to be Solved

For vibration resistance and the suppression of heat generation at a contact point in an electrical connection location, it is thought to require an increase of a contact pressure in a contact location. However, if the contact pressure is increased, a force required for connection increases and there is a possibility of deteriorating connection workability. In a technique disclosed in Patent Document 1, the shape-memory spring needs to be heated by energization when the male pin is inserted and a connecting operation is cumbersome.

Accordingly, the present disclosure aims to enable a connecting operation to be easily performed while achieving high connection reliability between a connecting member and a mating connecting member.

### Means to Solve the Problem

The present disclosure is directed to an electrical connection unit to be connected to a mating connecting member, the electrical connection unit being provided with a connecting member capable of contacting the mating connecting member and a biasing member for applying a contact pressure between the mating connecting member and the connecting member, the biasing member being made of shape-memory alloy memorizing a shape to enhance the contact pressure by a temperature increase.

### Effect of the Invention

According to the present disclosure, a connecting operation is easily performed while high connection reliability between a connecting member and a mating connecting member is achieved.

### BRIEF DESCRIPTION OF THE DRAWINGS

FIG. 1 is a schematic diagram showing a mechanically and electrically integrated unit according to an embodiment.

FIG. 2 is a perspective view showing an electrical connection unit.

FIG. 3 is a perspective view showing an outer connection end and a biasing member.

FIG. 4 is a side view showing the outer connection end and the biasing member.

FIG. 5 is a perspective view partly in section showing the outer connection end and the biasing member.

FIG. 6 is a diagram showing an operation example of connecting a busbar to the electrical connection unit.

FIG. 7 is a diagram showing an operation of the electrical connection unit in a used state.

### DETAILED DESCRIPTION TO EXECUTE THE INVENTION

### Description of Embodiments of Present Disclosure First, embodiments of the present disclosure are listed and described.

The electrical connection unit of the present disclosure is as follows.

(1) The electrical connection unit to be connected to a mating connecting member is provided a connecting member capable of contacting the mating connecting member and a biasing member for applying a contact pressure between the mating connecting member and the connecting member, the biasing member being made of shape-memory alloy memorizing a shape to enhance the contact pressure by a temperature increase.

According to the present disclosure, a connecting operation of the mating connecting member and the electrical connection unit is easily performed by performing the connecting operation in a state before the temperature increase. Further, since the contact pressure between the connecting member and the mating connecting member is enhanced by the temperature increase after connection, high connection reliability can be obtained.

(2) In the electrical connection unit of (1), the biasing member may be in contact with the connecting member in a connected state of the mating connecting member.

In this case, if the temperature of the connecting member is increased by Joule heat, heat is easily transferred to the biasing member. In this way, the temperature of the biasing member increases and the contact pressure is enhanced.

(3) In the electrical connection unit of (2), the biasing member may contact the connecting member from a side opposite to a contact location of the mating connecting member and the connecting member.

The Joule heat is thought to be easily generated in the contact location of the mating connecting member and the connecting member. Heat generated in this contact location is effectively transferred to the biasing member and the temperature of the biasing member easily increases.

(4) In the electrical connection unit of any one of (1) to (3), the biasing member may memorize the shape to enhance the contact pressure by a temperature increase from a temperature range of 25° C.±15° C. to 50° C. or higher.

In this case, the connecting operation of the mating connecting member and the electrical connection unit is easily performed by performing the connecting operation within the temperature range of 25° C.±15° C.. If the temperature of the biasing member increases to 50° C. by the Joule heat or the like, the contact pressure between the connecting member and the mating connecting member is enhanced, wherefore high connection reliability can be obtained.

(5) In the electrical connection unit of any one of (1) to (4), the connecting member may include a first contact portion for contacting the mating connecting member, a second contact portion for contacting the mating connecting member from a side opposite to the first contact portion and a spring portion for generating a resilient force for clamping the mating connecting member between the first and second contact portions.

In this case, even in a state before the temperature increase, a stably connected state of the mating connecting member and the connecting member can be maintained by the spring portion of the connecting member.

(6) In the electrical connection unit of (5), the biasing member may include a first biasing contact portion for contacting the first contact portion from a side opposite to a first contact location of the first contact portion and the mating connecting member, a second biasing contact portion for contacting the second contact portion from a side opposite to a second contact location of the second contact portion and the mating connecting member, and an intermediate spring portion for generating a resilient force for biasing the first and second biasing contact portions in directions toward each other.

The Joule heat is thought to be easily generated in the first and second contact locations. Heat generated in these contact locations is effectively transferred to the biasing member and the temperature of the biasing member easily increases. Further, the heated biasing member can effectively press the first and second contact portions toward the mating connecting member by the first and second biasing contact portions.

(7) In the electrical connection unit of (6), the intermediate spring portion may include an additional contact portion for contacting the connecting member.

In this way, the heat of the connecting member is easily transferred to the biasing member by the additional contact portion, and the temperature of the biasing member effectively increases. Heat is effectively transferred to the intermediate spring portion via the first biasing contact portion, the second biasing contact portion and the additional contact portion, and the temperature of the intermediate spring portion effectively increases.

(8) In the electrical connection unit of (7), the first and second contact portions may include positioning protrusions, the intermediate spring portion may include positioning recesses, the positioning protrusions being inserted into the positioning recesses, and the positioning protrusions may contact the intermediate spring portion while being fit into the positioning recesses.

In this way, the heat of the connecting member is easily transferred to the biasing member by a positioning structure of the biasing member.

(9) In the electrical connection unit of any one of (1) to (8), the biasing member may be made of Ni—Ti alloy or Ni—Ti—Cu alloy.

In this way, the biasing member can return to an original shape by shape memory due to a temperature increase, and the contact pressure between the connecting member and the mating connecting member can be enhanced by increasing an elastic modulus.

### Details of Embodiment of Present Disclosure

A specific example of an electrical connection unit of the present disclosure is described below with reference to the drawings. Note that the present disclosure is not limited to these illustrations, but is represented by claims and intended to include all changes in the scope of claims and in the meaning and scope of equivalents.

### Embodiment

Hereinafter, an electrical connection unit according to an embodiment is described. The electrical connection unit is a unit to be connected to a mating connecting member. In this embodiment, the electrical connection unit is incorporated into a rotating electric machine and coil wires in the rotating electric machine are connected to an electrical device. The electrical device is, for example, an inverter for driving and controlling the rotating electric machine. Such an electrical connection unit may be called a terminal block unit.

### Concerning Overall Configuration of Mechanically and Electrically Integrated Unit Provided with Electrical Connection Unit

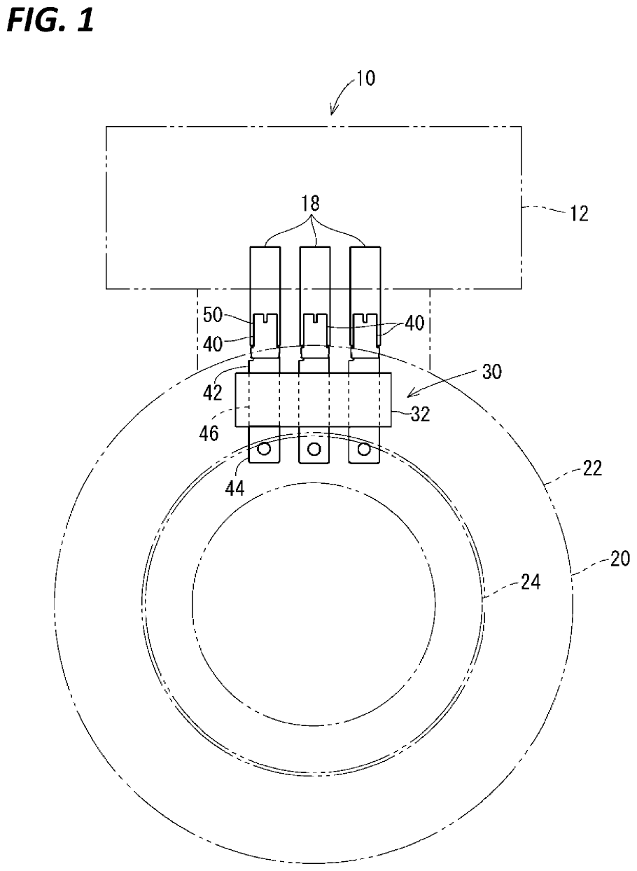

For the convenience of description, the overall configuration of the mechanically and electrically integrated unit obtained by integrating the rotating electric machine and the inverter is described. FIG. 1 is a schematic diagram showing an mechanically and electrically integrated unit 10. The mechanically and electrically integrated unit 10 is provided with a rotating electric machine 20 and an inverter 12.

The rotating electric machine 20 is provided with a case 22, an armature 24 and a field magnet. An example in which the armature 24 serving as a stator is fixed in the tubular case 22 is shown in FIG. 1. The field magnet is arranged in the armature 24 serving as a rotor. The field magnet is rotated by a magnetic field generated by the armature 24 or the armature 24 generates an electromotive force by the rotation of the field magnet. In this embodiment, the rotating electric machine 20 is assumed as a rotating electric machine usable as a three-phase alternating current motor. The rotating electric machine may be operable as a generator in addition to or instead of an operation as a motor. The rotating electric machine 20 may be used as a travel electric motor for driving a vehicle.

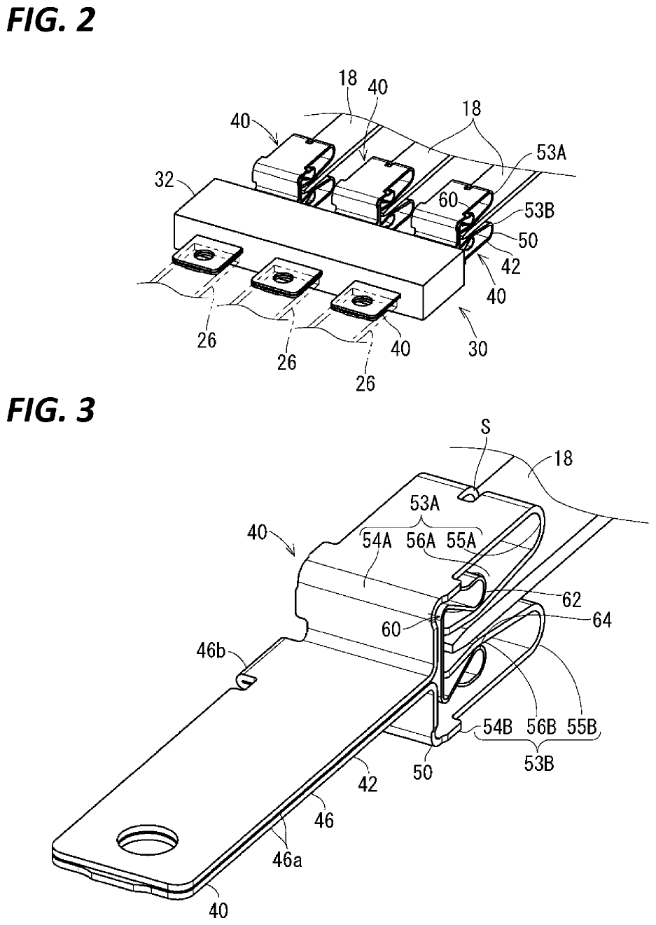

The armature 24 is provided with a stator core and a plurality of coil wires 26 (see FIG. 2). The stator core includes a plurality of teeth, and the plurality of teeth are provided to surround a rotary shaft. Each coil wire 26 is wound on one or more teeth. At least some of a plurality of end parts of the plurality of coil wires 26 are connection ends pulled out toward one end side in an axial direction of the armature 24 from between the plurality of teeth and to be electrically connected to the inverter 12.

The inverter 12 is a device including an inverter circuit. The inverter 12 is assumed to be integrated with the rotating electric machine 20. For example, the inverter 12 is integrated with the case 22 of the rotating electric machine 20 by bolt fixing or the like.

The inverter 12 is provided with busbars 18 connected to an output end of the inverter circuit. The busbar 18 is an elongated plate-like member made of a metal plate material such as copper or copper alloy. In this embodiment, three busbars 18 corresponding to three phases extend in parallel at intervals toward the rotating electric machine 20 from the inverter 12. A tip part of the busbar 18 may be formed to be gradually thinner toward a tip side (see FIGS. 3 to 5).

The electrical connection unit 30 is incorporated into the rotating electric machine 20 as one component constituting the rotating electric machine 20. The electrical connection unit 30 is provided with connection composite components 40. One end part of the connection composite component 40 is connected to an end part of the coil wire 26, and the other end part is supported at a position connectable to an end part of the busbar 18 of the inverter 12.

If an attempt is made to integrate the inverter 12 with the rotating electric machine 20 incorporated into the electrical connection unit 30, the busbars 18 are arranged at positions connectable to the other end parts of the connection composite components 40. In this way, the busbars 18 are connected to the corresponding connection composite components 40. The busbar 18 is an example of a mating connecting member to be connected to the connection composite component 40.

The electrical connection unit 30 is more specifically described. FIG. 2 is a perspective view showing the electrical connection unit 30. As shown in FIGS. 1 and 2, the electrical connection unit 30 is provided with the connection composite components 40. In this embodiment, the electrical connection unit 30 is provided with three connection composite components 40 respectively corresponding to the three phases.

The connection composite component 40 is a component to be connected to the busbar 18. The connection composite component 40 is provided with a connecting member 42 and a biasing member 60. The connecting member 42 is a member for contacting the busbar 18 and serving as a main current path. The biasing member 60 is a member for applying a contact pressure between the connecting member 42 and the busbar 18.

More specifically, the connecting member 42 is configured such that an inner connection end 44, the outer connection end 50 and an intermediate conductor 46 interposed between the inner connection end 44 and the outer connection end 50 are integrated. In this embodiment, the connecting member 42 in which the inner connection end 44, the outer connection end 50 and the intermediate conductor 46 are integrated is formed by press-working one metal plate material. Since being a part serving as a current path, the connecting member 42 is preferably made of metal better in electrical conductivity than the biasing member 60. The connecting member 42 is, for example, made of copper or copper alloy.

The inner connection end 44 is connected to the end part of the coil wire 26. For example, the coil wire 26 is constituted by a flat conductor, and the end part of the flat coil wire 26 is overlapped and arranged on the inner connection end 44. In this state, the end part of the coil wire 26 and the inner connection end 44 are fastened and fixed by a screw and a nut. Alternatively, a terminal is connected to the end part of the coil wire 26 by crimping or welding. This terminal is overlapped on the inner connection end 44 and fastened and fixed by a screw and a nut.

A connection configuration of the inner connection end 44 and the coil wire 26 is not particularly limited and may be welding, press-fit connection, crimp connection or the like. The end parts of the plurality of coil wires 26 may be connected to the connection composite component 40.

The intermediate conductor 46 is formed into an elongated shape. The intermediate conductor 46 may be linear or may be bent halfway. The inner connection end 44 is provided on one end part of the intermediate conductor 46 and the outer connection end 50 is provided on the other end part.

The electrical connection unit 30 is provided with a support base 32. The support base 32 holds the plurality of connection composite components 40 at fixed positions while insulating the connection composite components 40 from each other. In this embodiment, the support base 32 is in the form of a rectangular plate. For example, the support base 32 is formed by molding with the intermediate conductors 46 as inserts. The support base 32 may be configured by combining a plurality of components to support parts of the connection composite components 40 inside. The inner connection end 44 extends from the one end part of the intermediate conductor 46 and projects from a surface of the support base 32 on the side of the armature 24. In this way, the inner connection end 44 is arranged at a position connectable to the end part of the coil wire 26. The outer connection end 50 is exposed to outside from the support base 32. In this embodiment, the outer connection end 50 projects radially outwardly of the armature 24 from an outward facing surface of the support base 32 on a side opposite to the armature 24.

The support base 32 is fixed to the case 22 of the rotating electric machine 20 by screwing, a fit-in structure or the like. In this way, the rotating electric machine 30 is held at a fixed position in the rotating electric machine 20.

Note that a configuration for connecting the inner connection end 44 to a connection destination component thereof is arbitrary in the connecting member 42. Further, a configuration for holding the connecting member 42 is also arbitrary.

The outer connection end 50 projects outwardly of the rotating electric machine 20 from the support base 32 and is connected to the busbar 18. In this embodiment, the outer connection end 50 is configured to clamp the busbar 18. The biasing member 60 increases a contact pressure when the outer connection end 50 clamps the busbar 18.

### Concerning Outer Connection End

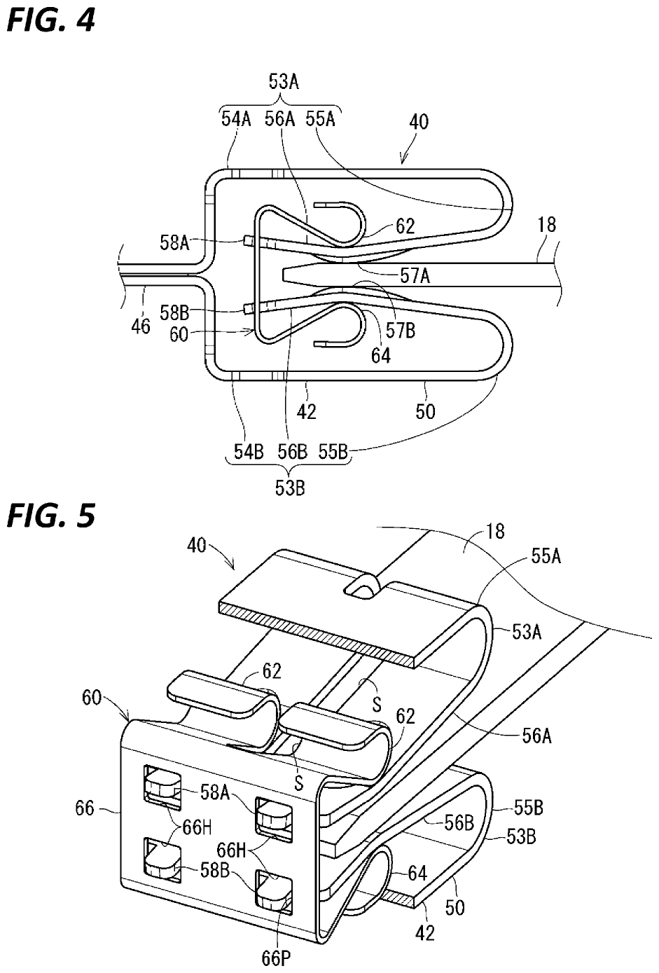

The outer connection end 50 of the connecting member 42 and the biasing member 60 are more specifically described. FIG. 3 is a perspective view showing the outer connection end 50 and the biasing member 60. FIG. 4 is a side view showing the outer connection end 50 and the biasing member 60. FIG. 5 is a perspective view partly in section showing the outer connection end 50 and the biasing member 60. The busbar 18 is partially shown in FIGS. 3 to 5.

The outer connection end 50 includes a first clamping portion 53A and a second clamping portion 53B. The first and second clamping portions 53A, 53B are facing each other in a thickness direction of the intermediate conductor 46. The end part of the busbar 18 is arranged between the first and second clamping portions 53A, 53B.

The first clamping portion 53A is a part formed by press-working a metal plate and includes a first base portion 54A, first spring portions 55A and first contact portions 56A.

The first base portion 54A includes a rectangular plate-like part bent from an edge on the other end of the intermediate conductor 46 toward one side in the thickness direction of the intermediate conductor 46 and a rectangular plate-like part extending in parallel to the intermediate conductor 46 from the leading edge of the former rectangular plate-like part in a direction away from the intermediate conductor 46. In a side view of the outer connection end 50, the first base portion 54A is a plate-like part bent into an L shape.

The first spring portion 55A is a part folded into a U shape from the tip of the first base portion 54A toward the second clamping portion 53B and the intermediate conductor 46. In this embodiment, the first clamping portion 53A includes a plurality of (here, two) the first spring portions 55A. The two first spring portions 55A are folded while being separated from each other across a gap. That is, a slit S is present between the two first spring portions 55A and the respective first spring portions 55A can be resiliently deformed without interfering with each other. The slit S may extend into the first base portion 54A. The slit S may be omitted.

The first contact portion 56A is a part for contacting the busbar 18. Here, the first contact portion 56A extends toward the intermediate conductor 46 from the tip of the first spring portion 55A. Here, a plurality of (here, two) the first contact portions 56A extend from the respective first spring portions 55A. The first contact portion 56A is so bent as to be closest to the second clamping portion 53B in an intermediate part between a base end side and a tip side. More specifically, an intermediate part in a longitudinal direction of the first contact portion 56A is bent at an obtuse angle and that bent part is convex toward the second clamping portion 53B.

The first contact portion 56A includes a partial protrusion 57A partially projecting toward the busbar 18 to be clamped. The partial protrusion 57A only has to be a protrusion when viewed from the busbar 18 to be clamped. For example, the partial protrusion 57A is formed, such as by press-working the metal plate. Thus, the partial protrusion 57A is a protrusion when viewed from the busbar 18 to be clamped, but may be a recess when viewed from an opposite side.

In this embodiment, the partial protrusion 57A is formed in a widthwise center of the bent part, out of the first contact portion 56A. The partial protrusion 57A is, for example, formed into a partial sphere elongated along an extension direction of the first contact portion 56A.

The first spring portion 55A can be resiliently deformed to bring the first contact portion 56A toward the first base portion 54A. The first contact portion 56A is biased toward the second clamping portion 53B by a resilient force of the first spring portion 55A to return an original shape.

A positioning protrusion 58A extends on the tip of the first contact portion 56A. The positioning protrusion 58A is formed to be narrower than the first contact portion 56A.

The second clamping portion 53B is a part formed by press-working the metal plate and includes a second base portion 54B, second spring portions 55B and second contact portions 56B.

Here, the intermediate conductor 46 is configured by overlapping two plate-like parts 46a. For example, the two plate-like parts 46a are bent to be overlapped via a bending part 46b (see FIG. 3). The two plate-like portions 46a are kept in an overlapped state via the bending portion 46b. One plate-like part 46a is formed with the first clamping portion 53A and the other plate-like part 46a is formed with the second clamping portion 53B, whereby the first and second clamping portions 53A, 53B can be formed by bending one metal plate. Note that the first and second clamping portions 53A, 53B may be joined and integrated by welding, crimping, screwing or the like.

The second base portion 54B, the second spring portions 55B and the second contact portions 56B are configured to be mirror-symmetrical to the first base portion 54A, the first spring portions 55A and the first contact portions 56A via a virtual plane in a center in the thickness direction of the busbar 18 to be clamped.

That is, the second base portion 54B includes a rectangular plate-like part bent from an edge of the one plate-like portion 46a toward a side opposite to the first base portion 54A and a rectangular plate-like part extending from the former rectangular plate-like part in the direction away from the intermediate conductor 46.

The second spring portion 55B is a part folded into a U shape from the tip of the second base portion 54B toward the second clamping portion 53B and the intermediate conductor 46. The second contact portion 56B extends from the tip of the second spring portion 55B toward the intermediate conductor 46. Similarly to the first clamping portion 53A including the plurality of first spring portions 55A and the plurality of second spring portions 56A, the second clamping portion 53B includes a plurality of the second spring portions 55B and a plurality of the second contact portions 56B. The second contact portion 56B is arranged at a position facing the first contact portion 56A and can contact the busbar 18 from a side opposite to the first contact portion 56A in the thickness direction of the busbar 18.

The second spring portions 55B and the second contact portions 56B are bent similarly to the first spring portions 55A and the first contact portions 56A. The second contact portion 56B includes a partial protrusion 57B and a positioning protrusion 58B, similarly to the first contact portion 56A.

A minimum gap between the first and second contact portions 56A, 56B in an initial state is smaller than a thickness of the busbar 18. In a state before the busbar 18 is clamped, the first and second contact portions 56A, 56B may or may not be in contact.

If the busbar 18 is inserted between the first and second contact portions 56A, 56B, the first and second spring portions 55A, 55B are resiliently deformed to increase the gap between the first and second contact portions 56A, 56B. With the busbar 18 arranged between the first and second contact portions 56A, 56B, the first and second contact portions 56A, 56B are biased in directions toward each other and clamp the busbar 18 by resilient forces of the first and second spring portions 55A, 55B to return to the original shapes. That is, the first and second spring portions 55A, 55B function as a spring portion for generating resilient forces for clamping the busbar 18 between the first and second contact portions 56A, 56B.

A configuration example of the spring portion for generating resilient forces for clamping the busbar 18 between the first and second contact portions 56A, 56B is not limited to the above example. For example, the spring portion may be configured to resiliently displaceably support only either first contact portions or second contact portions. Further, it is not essential that the outer connection end 50 includes the spring portion.

The biasing member 60 is a member for applying a contact pressure between the connecting member 42 and the busbar 18.

In this embodiment, the biasing member 60 is a member formed, such as by press-working a metal plate, and includes a first biasing contact portion 62, a second biasing contact portion 64, and an intermediate spring portion 66.

The intermediate spring portion 66 includes a pair of bent extended parts bent at an acute angle from both ends of a plate-like base part toward one principal surface side of the plate-like base part. For example, in a side view of the biasing member, the intermediate spring portion 66 is shaped to include a base and corners on both ends of the base of an isosceles triangle.

The first biasing contact portion 62 extends from one end part of the intermediate spring portion 66, and the second biasing contact portion 64 extends from the other end part of the intermediate spring portion 66. The first and second biasing contact portions 62, 64 extend in directions toward each other with distance from the intermediate spring portion 66. Tip parts of the first and second biasing contact portions 62, 64 are folded outward in a loop manner. Note that a plurality of (here, two) the first biasing contact portions 62 are separated via a slit to correspond to the plurality of (here, two) first contact portions 56A separated via the slit S. Similarly, a plurality of (here, two) the second biasing contact portions 64 are separated via a slit to correspond to the plurality of (here, two) second contact portions 56B separated via the slit S.

The first and second biasing contact portions 62, 64 can be opened while resiliently deforming the intermediate conductor 66. The first and second biasing contact portions 62, 64 can be biased in approaching directions by resilient forces of the intermediate spring portion 66 to return to an original shape.

The intermediate spring portion 66 is formed with positioning recesses 66H, into which the positioning protrusions 58A, 58B are fittable. Here, the positioning protrusion 66H is a hole penetrating through the intermediate spring portion 66 in the thickness direction, and a plurality of (here, four) positioning recesses 66H are formed to correspond to a plurality of (here, four) the positioning protrusions 58A, 58B.

In an initial state before the connection of the busbar 18, the biasing member 60 is attached to the connecting member 42 as follows.

That is, the biasing member 60 is externally fit to the first and second contact portions 56A, 56B from tip sides of the first and second contact portions 56A, 56B in a space between the first and second base portions 54A, 54B.

At this time, closest parts of the first and second biasing contact portions 62, 64 are arranged in recessed parts in the outer surfaces of the first and second contact portions 56A, 56B. The recessed parts in the outer surfaces of the first and second contact portions 56A, 56B are located on sides opposite to the most projecting parts of the inner surfaces (i.e. facing surfaces) of the first and second contact portions 56A, 56B. The most projecting parts of the inner surfaces (i.e. facing surfaces) of the first and second contact portions 56A, 56B are parts for contacting the busbar 18. Thus, the biasing member 60 can contact the contact portions 56A, 56B from sides opposite to contact locations of the contact portions 56A, 56B of the connecting member 42 and the busbar 18. Note that, when viewed along an acting direction of a contact pressure between the contact portions 56A, 56B and the busbar 18, at least parts of contact regions of the biasing member 60 and the contact portions 56A, 56B may overlap at least parts of contact regions of the contact portions 56A, 56B and the busbar 18.

Further, the positioning protrusions 58A, 58B can be fit into the positioning recesses 66H. In this way, the biasing member 60 is hardly displaced laterally with respect to the first and second contact portions 56A, 56B. With the positioning protrusions 58A, 58B fit in the positioning recesses 66H, the positioning protrusions 58A, 58B may be in contact with the intermediate spring portion 66. Parts 66P of the positioning protrusions 58A, 58B in contact with the intermediate spring portion 66 can function as additional contact portions 66P where the intermediate spring portion 66 is in contact with the connecting member 42 at locations different from parts where the first and second biasing contact portions 62, 64 and the first and second contact portions 56A, 56B are in contact.

A minimum gap between the first and second biasing contact portions 62, 64 in the initial state is preferably smaller than a minimum width between the outer surfaces of the first and second contact portions 56A, 56B in the initial state. In this way, in the initial state before the connection of the busbar 18, the first and second contact portions 56A, 56B can be clamped between the first and second biasing contact portions 62, 64 by resilient forces of the intermediate spring portion 66.

The biasing member 60 is made of shape-memory alloy memorizing a shape to enhance the contact pressure between the connecting member 42 and the busbar 18 by a temperature increase.

A temperature before the contact pressure is enhanced is, for example, a temperature at which an operation of connecting the busbar 18 to the connecting member 42 is performed, and belongs to normal temperature. The normal temperature is, for example, 25° C.±15° C. Temperatures mentioned below are Celsius temperatures.

A temperature at which the contact pressure is enhanced is a temperature higher than the temperature at which the operation of connecting the busbar 18 to the connecting member 42 is performed. The temperature at which the contact pressure is enhanced may be, for example, a temperature exceeding the normal temperature. The temperature at which the contact pressure is enhanced may be, for example, a temperature obtained by adding the influence of heating such as Joule heat to a use environment temperature of the electrical connection unit 30. The temperature at which the contact pressure is enhanced may be, for example, a temperature higher than 50° C.

That is, the biasing member 60 may memorize the shape to enhance the contact pressure by a temperature increase from a temperature range of 25° C.±15° C. to 50°° C. or higher.

The shape may be memorized to enhance the contact pressure by being changed or changing a physical value by a temperature increase.

For example, the biasing member 60 is thought to memorize the shape to make the minimum gap between the first and second biasing contact portions 62, 64 after the contact pressure is enhanced smaller than this minimum gap at the temperature before the contact pressure is enhanced. That is, the minimum gap between the first and second biasing contact portions 62, 64 is made smaller by a temperature increase.

Further, the biasing member 60 may, for example, memorize the shape such that an elastic modulus, which is an example of the physical value, is increased by a temperature increase and a spring load can be increased.

The shape-memory alloy may be, for example, a Ni—Ti alloy or a Ni—Ti—Cu alloy. If the Ni—Ti alloy or the Ni—Ti—Cu alloy is used, the shape can be memorized to be changed or increase the elastic modulus by a temperature change from the temperature range of 25° C.±15° C. to 50° C. or higher. In this way, forces of the biasing contact portions 62, 64 to bias the contact portions 56A, 56B in the approaching directions can be enhanced by the temperature increase.

Note that the shape-memory alloy may be an alloy other than the Ni—Ti alloy or the Ni—Ti—Cu alloy.

### Concerning Operation of Electrical Connection Unit

The operation of the electrical connection unit 30 is described.

In the initial state, the biasing member 60 is attached to the outer connection end 50 of the connecting member 42. Note that, before the temperature increase (e.g. at normal temperature), the gap between the biasing contact portions 62 and 64 is thought to be open relatively large. Thus, the biasing member 60 can be easily attached to the outer connection end 50.

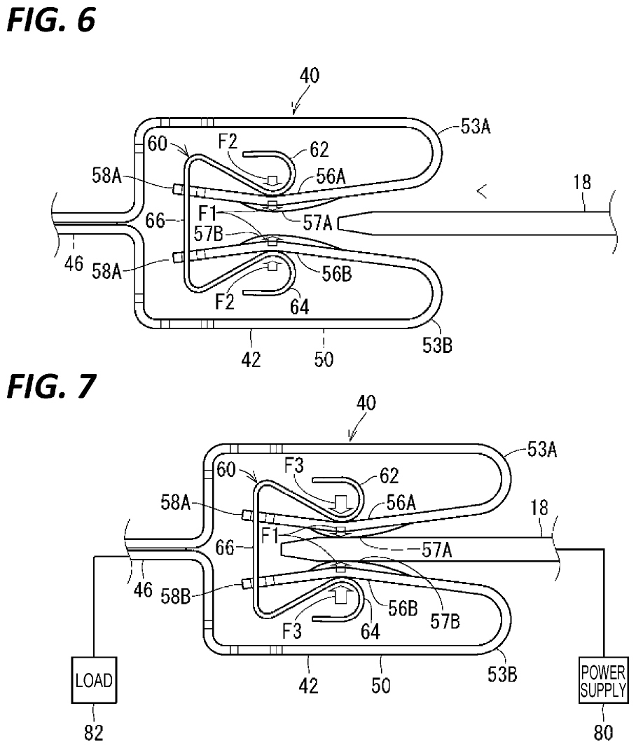

As shown in FIG. 6, the busbar 18 is connected to the outer connection end 50. That is, the busbar 18 is inserted between the contact portions 56A, 56B. Then, the busbar 18 contacts facing parts of the contact portions 56A, 56B, here the partial protrusions 57A, 57B. The contact portions 56A, 56B are pushed apart in directions separating from each other to form a gap corresponding to the thickness of the busbar 18 between the contact portions 56A and 56B. At this time, a biasing force F1 by spring loads of the spring portions 55A, 55B and a biasing force F2 by a spring load of the biasing member 60 act on the contact portions 56A, 56B. Thus, during an operation of inserting the busbar 18, a contact pressure by a resultant force of the biasing forces F1 and F2 acts between the contact portions 56A, 56B and the busbar 18. Therefore, a friction force proportional to the resultant force of the biasing forces F1, F2 acts between the contact portions 56A, 56B and the busbar 18.

The biasing force F2 is smaller than a biasing force F3 after the temperature increase. Thus, a force required to connect the busbar 18 can be reduced. Further, the plating wear of the busbar 18 and the contact portions 56A, 56B can be suppressed by reducing the contact pressure during the connecting operation. In this way, in a connected state of the connection composite component 40 and the busbar 18, plating functions of preventing oxidation and corrosion are exhibited and high connection reliability is obtained.

Note that, even in a state where the inserting operation of the busbar 18 is finished, the contact pressure by the resultant force of the biasing forces F1, F2 acts between the contact portions 56B, 56B and the busbar 18 at normal temperature.

If the electrical connection unit 30 is used as a relay connection location of an electric circuit, a power supply 80 can be electrically connected to one of the busbar 18 and the connecting member 42 and a load 82 can be electrically connected to the other as shown in FIG. 7. Thus, a current flows in the busbar 18 and the connecting member 42.

If the current flows in the busbar 18 and the connecting member 42, the temperatures of the busbar 18 and the connecting member 42 are increased by Joule heat. The temperature is thought to be easily increased by the Joule heat in a contact location of the busbar 18 and the connecting member 42. Heat of the busbar 18 and the connecting member 42 is transferred to the biasing member 60, and the temperature of the biasing member 60 also increases. In this way, the biasing member 60 is deformed into a memorized shape or the physical value such as the elastic modulus of the biasing member 60 is changed, and the spring load by the biasing member 60 is increased. Then, the biasing force F3 by the biasing member 60 becomes larger than the biasing force F2. Thus, the contact pressure between the busbar 18 and the connecting member 42 also increases. In this way, the busbar 18 and the connecting member 42 are maintained in a stable contact state also under vibration conditions. Further, electrical resistances of the busbar 18 and the connecting member 42 decrease and excessive heat generation in the contact location is suppressed.

For example, if the electrical connection unit 30 is applied to a power supply circuit or a circuit, to which a high pressure is applied, heat generation by Joule heat is expected. The high pressure is, for example, 60 V or more, more preferably 90 V or more. Of course, the electrical connection unit 30 may be applied to a signal circuit or a circuit, to which a low pressure is applied.

A temperature increase of the connecting member 42 may be brought about by heat other than the Joule heat in the busbar 18 and the connecting member 42. For example, the temperature of the connecting member 42 may be increased by the heat of a control device around the electrical connection unit 30, the heat of a drive circuit, the heat of an internal combustion engine or the heat of a battery.

### Effects, Etc.

The electrical connection unit 30 configured as described above is provided with the connecting member 42 capable of contacting the busbar 18 and the biasing member 60 for applying a contact pressure between the busbar 18 and the connecting member 42, and the biasing member 60 is made of shape-memory alloy memorizing the shape to enhance the contact pressure by a temperature increase.

Thus, by performing the connecting operation of the busbar 18 and the electrical connection unit 30 in a state before the temperature increase, this connecting operation is easily performed with a low insertion force. Further, since the contact pressure between the busbar 18 and the connecting member 42 is smaller than that after the temperature increase, the plating wear of the busbar 18 and the connecting member 42 is suppressed. Thus, plating functions are exhibited in the connected state of the busbar 18 and the connecting member 42, and the connection reliability of the busbar 18 and the connecting member 42 is ensured.

Further, the contact pressure between the connecting member 42 and the busbar 18 is increased and vibration resistance is ensured after the temperature increase. Further, an electrical resistance between the connecting member 42 and the busbar 18 is reduced and heat generation in the contact location of those is suppressed. In this way, high connection reliability is obtained in a temperature increased state. Further, since the contact pressure between the busbar 18 and the connecting member 42 returns to a relatively low state upon return to normal temperature, maintenance associated with the insertion and withdrawal of the busbar 18 into and from the connecting member 42 can be easily performed.

For example, for vibration resistance and the suppression of heat generation at contact points, it is assumed to increase a spring load of a terminal. In this case, a force required for connection increases and connection workability may be possibly deteriorated. To enhance connection workability, it is thought to incorporate a lever using the principle of leverage or use a fastening force of a bolt. In these cases, there is a possibility of a weight increase, enlargement and complication.

According to the electrical connection unit 30, the connecting operation can be facilitated and the connection reliability can be improved while the weight increase, the enlargement and the enlargement are suppressed. Note that, in the electrical connection unit 30, the connection structure using the lever or the bolt may be applied.

Further, since the biasing member 60 is in contact with the connecting member 42 with the busbar 18 and the connecting member 42 connected, if the temperature of the connecting member 42 increases due to Joule heat, that heat is easily transferred to the biasing member 60. In this way, in a used state of the electrical connection unit 30, the temperature of the connecting member 42 easily increases and the contact pressure is effectively enhanced.

Further, the Joule heat is thought to be easily generated in the contact location of the busbar 18 and the connecting member 42. Accordingly, if the biasing member 60 contacts the connecting member 42 from a side opposite to the contact location of the busbar 18 and the connecting member 42, heat generated in this contact location is easily transferred to the biasing member 60. In this way, in the used state of the electrical connection unit 30, the temperature of the connecting member 42 more easily increases and the contact pressure is more effectively enhanced.

If the biasing member 60 memorizes the shape to enhance the contact pressure by a temperature increase from the temperature range of 25° C.±15° C. to 50° C. or higher, the connecting operation of the busbar 18 and the electrical connection unit 30 is easily performed if the connecting operation is performed within the temperature range of 25° C.±15° /c. If the temperature of the biasing member 60 increases to 50° C. due to Joule heat or the like, the contact pressure between the busbar 18 and the connecting member 42 increases, wherefore high connection reliability can be obtained.

Further, if the biasing member 60 is made of Ni—Ti alloy or Ni—Ti—Cu alloy, the biasing member 60 can return to the original shape by shape memory and the contact pressure between the connecting member 42 and the busbar 18 can be enhanced by increasing the elastic modulus at the time of a temperature increase.

Further, since the connecting member 42 includes the first contact portions 56A, the second contact portions 56B and the spring portions 55A, 55B, the busbar 18 and the connecting member 42 can be maintained in the stably connected state by the spring portions 55A, 55B of the connecting member 42.

Further, the biasing member 60 includes the first biasing contact portions 62, the second biasing contact portions 64 and the intermediate spring portion 66, the first biasing contact portions 62 contact the first contact portions 56A from the side opposite to the first contact locations of the first contact portions 56A and the busbar 18, and the second biasing contact portions 64 contact the second contact portions 56B from the side opposite to the contact locations of the second contact portions 56B and the busbar 18. Since the Joule heat is assumed to be easily generated in the first and second contact locations, heat generated in those contact locations is effectively transferred to the biasing member 60. Further, the biasing member 60, the temperature of which has increased, can effectively press the first and second contact portions 56A, 56B toward the busbar 18 by the first and second biasing contact portions 62, 64. In this way, the contact pressure is effectively enhanced and the connection reliability is enhanced in the used state of the electrical connection unit 30.

Further, since the intermediate spring portion 66 includes the additional contact portions 66P to be held in contact with the connecting member 42, the heat of the connecting member 42 is easily transferred to the biasing member 60 also by these additional contact portions 66P. In this way, the heat is transferred to the biasing member 60 via the first biasing contact portions 62, the second biasing contact portions 64 and the additional contact portions, and the temperature of the intermediate spring portion 66 effectively increases.

Further, the first and second contact portions 56A, 56B include the positioning protrusions 58A, 58B, and the intermediate spring portion 66 includes the positioning recesses 66H, into which the positioning protrusions 58A, 58B are inserted. The positioning protrusions 58A, 58B contact the intermediate spring portion 66 while being fit in the positioning recesses 66H. Thus, the heat of the connecting member 42 can be easily transferred to the biasing member 60, utilizing a positioning structure.

### Modifications

Although the electrical connection unit 30 has been described as a terminal block unit in this embodiment, the configuration relating to the electrical connection unit 30 can be applied to various electrically connecting portions other than the terminal block unit.

Note that the respective configurations described in the above embodiment and each modification can be appropriately combined without contradicting each other.

### List of Reference Numerals

10 mechanically and electrically integrated unit
12 inverter
18 busbar (mating connecting member)
20 rotating electric machine
22 case
24 armature
26 coil wire
30 electrical connection unit
32 support base
40 connection composite component
42 connecting member
44 inner connection end
46 intermediate conductor
46a plate-like part
46b bending part
50 outer connection end
53A first clamping portion
53B second clamping portion
54A first base portion
54B second base portion
55A first spring portion (spring portion)
55B second spring portion (spring portion)
56A first contact portion
56B second contact portion
57A, 57B partial protrusion
58A, 58B positioning protrusion
60 biasing member
62 first biasing contact portion
64 second biasing contact portion
66 intermediate spring portion
66H positioning recess
66P additional contact portion
80 power supply
82 load
S slit

1. An electrical connection unit to be connected to a mating connecting member, the electrical connection unit being a component for connecting a rotating electric machine and an inverter in a mechanically and electrically integrated unit obtained by integrating the rotating electric machine and the inverter, comprising:
a connecting member capable of contacting the mating connecting member; and
a biasing member for applying a contact pressure between the mating connecting member and the connecting member,
the biasing member being made of shape-memory alloy memorizing a shape to enhance the contact pressure by a temperature increase, and
the biasing member being configured to memorize the shape to enhance the contact pressure by Joule heat of electricity flowing in the mating connecting member and the connecting member in a first connected state of the mating connecting member and the connecting member after the biasing member is attached to the connecting member.

2. The electrical connection unit of claim 1, wherein:
the biasing member is in contact with the connecting member in a connected state of the mating connecting member, and
the biasing member memorizes the shape such that an elastic modulus is increased to be able to increase a spring load by the temperature increase.

3. The electrical connection unit of claim 2, wherein the biasing member contacts the connecting member from a side opposite to a contact location of the mating connecting member and the connecting member.

4. The electrical connection unit of claim 1, wherein the biasing member memorizes the shape to enhance the contact pressure by a temperature increase from a temperature range of 25° C.±15° C. to 50° C. or higher.

5. The electrical connection unit of claim 1, wherein the connecting member includes a first contact portion for contacting the mating connecting member, a second contact portion for contacting the mating connecting member from a side opposite to the first contact portion and a spring portion for generating a resilient force for clamping the mating connecting member between the first and second contact portions.

6. The electrical connection unit of claim 5, wherein the biasing member includes a first biasing contact portion for contacting the first contact portion from a side opposite to a first contact location of the first contact portion and the mating connecting member, a second biasing contact portion for contacting the second contact portion from a side opposite to a second contact location of the second contact portion and the mating connecting member, and an intermediate spring portion for generating a resilient force for biasing the first and second biasing contact portions in directions toward each other.

7. The electrical connection unit of claim 6, wherein the intermediate spring portion includes an additional contact portion for contacting the connecting member.

8. The electrical connection unit of claim 7, wherein:
the first and second contact portions include positioning protrusions,
the intermediate spring portion includes positioning recesses, the positioning protrusions being inserted into the positioning recesses, and
the positioning protrusions contact the intermediate spring portion while being fit into the positioning recesses.

9. The electrical connection unit of claim 1, wherein the biasing member is made of Ni—Ti alloy or Ni—Ti—Cu alloy.
